(19) United States
(12) Patent Application Publication
(10) Pub. No.: US 2025/0384068 A1
(43) Pub. Date: Dec. 18, 2025

(54) METHOD, DEVICE, AND COMPUTER PROGRAM PRODUCT FOR DETERMINING SERVICE MODE

(71) Applicant: Dell Products L.P., Round Rock, TX (US)

(72) Inventors: Zijia Wang, London (GB); Wenlei Wu, Shanghai (CN); Wenqing Peng, Dezhou (CN); Jinpeng Liu, Shanghai (CN); Zhen Jia, Shanghai (CN)

(21) Appl. No.: 18/762,969

(22) Filed: Jul. 3, 2024

(30) Foreign Application Priority Data
Jun. 17, 2024 (CN) 202410780656.3

(51) Int. Cl. G06F 16/33; G06F 16/383

(52) U.S. Cl. CPC G06F 16/3344; G06F 16/383

(57) ABSTRACT

The present disclosure relates to a method, a device, and a computer program product for determining a service mode. The method includes generating an intent parameter by identifying a user intent in a query content input by a user. The method further includes generating an emotion parameter by analyzing a sentiment inclination in the query content. The method further includes generating a confidence parameter by analyzing a similarity between the query content and training data for training an adaptive strategy model. The method further includes determining a service mode for replying to the query content based on the intent parameter, the emotion parameter, and the confidence parameter. In this way, the optimal service mode can be accurately and timely determined without affecting the query process and losing information, ensuring the coherence and consistency of the user experience, thus improving the user experience.

### RELATED APPLICATION

The present application claims priority to Chinese Patent Application No. 202410780656.3, filed Jun. 17, 2024, and entitled “Method, Device, and Computer Program Product for Determining Service Mode,” which is incorporated by reference herein in its entirety.

### FIELD

The present disclosure relates to the field of artificial intelligence, and more particularly, to a method, a device, and a computer program product for determining a service mode.

### BACKGROUND

With the rapid development of science and technology and the popularity of the Internet, there is a growing demand from users for service response speed and personalized experience. In such a market environment, the application of chatbots in customer service and contact centers is on the rise. Based on natural language processing (NLP) and machine learning technologies, typical chatbots can understand and analyze human language, and respond quickly to user queries through preset algorithms and rules.

In addition, chatbots can also provide personalized service suggestions by collecting and analyzing historical data of customers, so as to improve customer satisfaction. This efficient and convenient service mode allows chatbots to be widely embraced and applied in the fields of user service and contact centers.

### SUMMARY

Embodiments of the present disclosure provide a method, a device, and a computer program product for determining a service mode.

In a first aspect of embodiments of the present disclosure, a method for determining a service mode is provided. The method includes generating an intent parameter by identifying a user intent in a query content input by a user. The method further includes generating an emotion parameter by analyzing a sentiment inclination in the query content. The method further includes generating a confidence parameter by analyzing a similarity between the query content and training data for training an adaptive strategy model. The method further includes determining a service mode for replying to the query content based on the intent parameter, the emotion parameter, and the confidence parameter.

In a second aspect of embodiments of the present disclosure, an electronic device is provided. The electronic device includes at least one processor, and a memory coupled to the at least one processor and having instructions stored therein. The instructions, when executed by the at least one processor, cause the electronic device to perform actions comprising: generating an intent parameter by identifying a user intent in a query content input by a user; generating an emotion parameter by analyzing a sentiment inclination in the query content; generating a confidence parameter by analyzing a similarity between the query content and training data for training an adaptive strategy model; and determining a service mode for replying to the query content based on the intent parameter, the emotion parameter, and the confidence parameter.

In a third aspect of embodiments of the present disclosure, a computer program product is provided. The computer program product is tangibly stored on a non-transitory computer-readable medium and comprises machine-executable instructions. The machine-executable instructions, when executed by a machine, cause the machine to perform actions comprising: generating an intent parameter by identifying a user intent in a query content input by a user; generating an emotion parameter by analyzing a sentiment inclination in the query content; generating a confidence parameter by analyzing a similarity between the query content and training data for training an adaptive strategy model; and determining a service mode for replying to the query content based on the intent parameter, the emotion parameter, and the confidence parameter.

It should be understood that the content described in this Summary is neither intended to define key or essential features of embodiments of the present disclosure, nor intended to limit the scope of the present disclosure. Other features of the present disclosure will become readily understood from additional description herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 is a schematic diagram of an example environment in which multiple embodiments of the present disclosure can be implemented;

FIG. 2 is a flow chart of a method for determining a service mode according to some embodiments of the present disclosure;

FIG. 3 is a flow chart of a method for replying to a query content using a model according to some embodiments of the present disclosure;

FIG. 4 is a schematic diagram of a process of replying to a query content according to some embodiments of the present disclosure;

FIG. 5 is a flow chart of a method for determining a service mode according to a preset condition and a preset scenario according to some embodiments of the present disclosure; and

FIG. 6 is a block diagram of a device that can implement multiple embodiments of the present disclosure.

### DETAILED DESCRIPTION

Embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.”

The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included herein.

In the field of customer service, although machine reply has been widely used, it is still necessary to rely on professional human service to ensure service quality and customer satisfaction when dealing with complicated, specific, or sensitive questions. Although the existing chatbot technology is quite advanced, it still shows obvious shortcomings in determining when to adopt what service mode. One of the main problems is that it is very difficult to determine the optimal service mode at the right time.

In related art, determination of the service mode mostly depends on a single algorithm decision, which has obvious limitations when dealing with complicated scenarios. When a chatbot encounters a question that is difficult to answer, a single algorithm may not be able to accurately determine and provide the most appropriate service mode, and may provide services at an inappropriate timing, or bring in a human agent too soon when it is not needed, resulting in degraded service efficiency and compromised customer satisfaction. In addition, using a single algorithm to make decisions also results in lack of consistent experience across channels and platforms and the scalability and adaptability of chatbots, which makes it difficult for the system to adapt to the personalized needs and preferences of different user groups and the rapidly changing market environment. Therefore, it has become an important challenge for the development of chatbot technology to optimize the service mode decision mechanism and improve the service quality and customer satisfaction.

To this end, embodiments of the present disclosure provide a solution for determining a service mode. This solution includes generating an intent parameter by identifying a user intent in a query content input by a user; generating an emotion parameter by analyzing a sentiment inclination in the query content; generating a confidence parameter by analyzing a similarity between the query content and training data for training an adaptive strategy model; and determining a service mode for replying to the query content based on the intent parameter, the emotion parameter, and the confidence parameter. In this way, the optimal service mode can be accurately and promptly determined without affecting the query process or losing information, while ensuring the coherence and consistency of the user experience, thus improving the user experience.

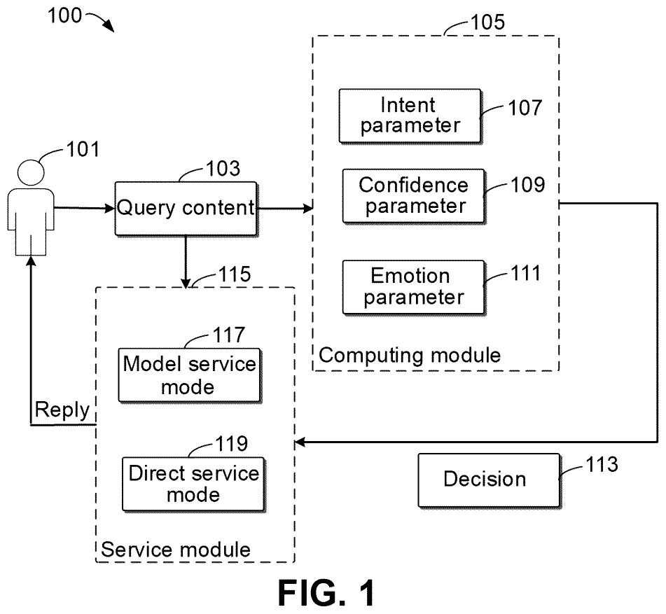

FIG. 1 shows a schematic diagram of an example environment 100 in which multiple embodiments of the present disclosure can be implemented. As shown in FIG. 1, the example environment 100 may include a query content 103, which may be contents in various forms including text, voice, image, video, and the like, such as questions, requests, instructions, and the like, input by a user 101. The user 101 inputs the query content 103 into a service module 115, and the service module 115 generates a reply corresponding to the query content 103. The service module 115 may be a component or unit that provides services in a runtime environment. The service module 115 may be a standalone deployment unit, which includes codes, data, libraries, and other resources needed to perform specific functions.

As shown in FIG. 1, the service module 115 may include a model service mode 117 and a direct service mode 119. The model service mode 117 can provide a reply service for the user 101 based on a model, which may be a machine learning model, such as a supervised learning model, an unsupervised learning model, a reinforcement learning model, and the like. The direct service mode 119 may be a mode in which services are provided by one or more humans, such as human customer service agents, technical support personnel, and the like. When the service module 115 is in a general scenario, an efficient and convenient reply service can be provided in the model service mode 117. When the service module 115 deals with complicated, specific or sensitive questions, the model service mode 117 can be switched to the direct service mode 119 to ensure the service quality and customer satisfaction with a professional human reply.

In some embodiments, the switching decision 113 of switching from the model service mode 117 to the direct service mode 119 can be generated by a computing module 105. The computing module 105 may be a server or a device capable of generating the switching decision 113, such as a search engine server, a database server, a computing cluster, and the like. The computing module 105 can obtain the query content 103 from the user 101 and identify and analyze the query content 103 to generate the switching decision 113.

In some embodiments, the computing module 105 can generate an intent parameter 107 by identifying a user intent in the query content 103 input by the user. When identifying the user intent in the query content 103 input by the user, the computing module 105 can adopt a method based on rules to identify the intent according to the keywords, phrases, or specific patterns input by the user by predefining a series of rules, or adopt a method based on semantic analysis for semantic analysis of the query input by the user by using natural language processing technology to understand the deep meaning and intent therein, such as the language understanding intelligent service (LUIS), and can also train a machine learning model to identify the query intent of the user. In specific implementations, the accuracy and efficiency of identification can be improved by choosing an appropriate method or combining multiple methods depending on specific requirements and scenarios.

The computing module 105 can also generate an emotion parameter 111 by analyzing the sentiment inclination in the query content 103. When analyzing the sentiment inclination in the query content 103, the computing module 105 can match and compute the sentiment inclination in the content by using the words in an established sentiment lexicon and their corresponding sentiment polarities (positive, negative, and neutral) and intensities, and can also automatically identify and classify the sentiment inclination of the text by training the machine learning model. The method of sentiment inclination analysis can be chosen depending on actual needs, and further description thereof is omitted herein.

The computing module 105 can also analyze a similarity between the query content 103 and the training data for training an adaptive strategy model to generate a confidence parameter 109. The service mode using the adaptive strategy model may be one of the model service modes, and the adaptive strategy model may be one of the machine learning models, which can automatically generate a reply according to the query content 103. In embodiments of the present disclosure, the service mode for replying to the query content 103 is determined according to the intent parameter 107, the emotion parameter 111, and the confidence parameter 109 computed by the computing module 105, which can improve the accuracy and efficiency of the service by accurately understanding the query intent of the user and perceiving the emotional status of the user, thus providing a more personalized reply and solution, while presenting high extensibility and portability to adapt to the application requirements of different fields and scenarios.

As is apparent from the description above, this solution includes generating an intent parameter by identifying a user intent in a query content input by a user; generating an emotion parameter by analyzing a sentiment inclination in the query content; generating a confidence parameter by analyzing a similarity between the query content and training data for training an adaptive strategy model; and determining a service mode for replying to the query content based on the intent parameter, the emotion parameter, and the confidence parameter. In this way, the intent and sentiment inclination in the user query can be accurately identified, and the similarity with the training data can be evaluated, so that the optimal service mode can be accurately and promptly determined without affecting the query process and losing information. Based on multi-dimensional parameters, it can be determined in real time when, where, and how to transition smoothly from one service mode to another. Such switching not only ensures the coherence of the query process and the integrity of the information, but also improves the user experience.

It should be understood that description of the architecture and function in the example environment 100 is made for illustrative purposes only and does not imply any limitation to the scope of the present disclosure. Embodiments of the present disclosure may also be applied to other environments having different structures and/or functions.

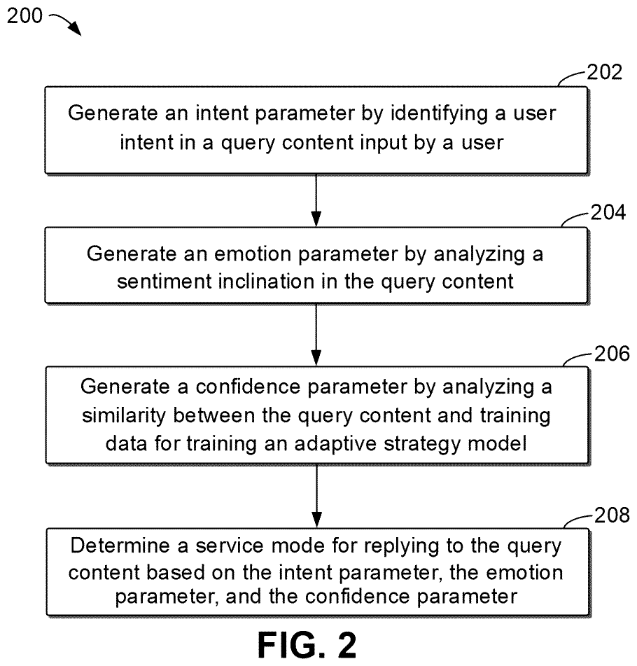

Example processes according to embodiments of the present disclosure will be described in detail below with reference to FIGS. 2 to 6. For ease of understanding, the specific data mentioned in the following description is all intended for purposes of illustration only and is not intended to define the scope of the present disclosure. It can be understood that the embodiments described below may also include additional actions not shown and/or may omit actions shown, and the scope of the present disclosure is not limited in this regard.

FIG. 2 is a flow chart of a method 200 for determining a service mode according to some embodiments of the present disclosure. At block 202, an intent parameter is generated by identifying a user intent in a query content input by a user. As shown in FIG. 1, for example, the user intent in the query content 103 input by the user can be identified by using the computing module 105 to generate the intent parameter 107. When the user 101 inputs the query content 103, the user intent can be identified by using a method conventionally used in related art, which can be chosen depending on actual requirements and scenarios in specific implementations to improve the accuracy and efficiency of intent identification.

At block 204, an emotion parameter is generated by analyzing a sentiment inclination in the query content. As shown in FIG. 1, for example, the sentiment inclination in the query content 103 can also be analyzed by using the computing module 105 to generate the emotion parameter 111. The sentiment inclination may be a specific indicator to describe and quantify the emotional status, and the emotional status of the user 101 can be accurately understood and analyzed through the sentiment inclination. When analyzing the sentiment inclination in the query content 103, the computing module 105 can match and compute the sentiment inclination in the content based on a naive Bayesian classifier, for example, using Text Blob for sentiment analysis. Text Blob is an open source text processing library written in Python. The sentiment inclination of the text can also be automatically identified and classified by training the machine learning model. The method of sentiment inclination analysis can be chosen depending on actual needs, and further description thereof is omitted herein.

At block 206, a confidence parameter is generated by analyzing a similarity between the query content and training data for training an adaptive strategy model. As shown in FIG. 1, for example, the similarity between the query content 103 and the training data for training the adaptive strategy model can be analyzed by using the computing module 105 to generate a confidence, which may be generated by using a natural language service such as a large language model. Then, the confidence parameter 109 is generated based on the confidence. For example, if the score of similarity between the query content 103 and the training data is high, a high confidence can be generated; if the score of similarity is in a medium range, a medium confidence is generated; and if the score of similarity is low or similar training samples cannot be found, a low confidence is generated. The confidence parameter 109 can be generated according to the confidence, and the generation method and rule can be selected depending on actual needs.

At block 208, a service mode for replying to the query content is determined based on the intent parameter, the emotion parameter, and the confidence parameter. As shown in FIG. 1, for example, the service module 115 may include the model service mode 117 and the direct service mode 119. The model service mode 117 can provide a reply service for the user 101 based on a model, and the direct service mode 119 may be a mode in which services are provided by one or more humans, such as human customer service agents, technical support personnel, and the like. By determining the service mode according to the intent parameter 107, the emotion parameter 111, and the confidence parameter 109, the intent and sentiment inclination in the query content 103 can be accurately identified, and the similarity with the training data can be evaluated, so as to intelligently determine and adjust the service mode.

In this way, the optimal point and standard for switching from one service mode to another can be determined in real time through multi-dimensional parameters, and the smooth and seamless switching from one service mode to another can be realized without affecting the query process and losing information, thus ensuring the coherence and consistency of the user experience and improving the user experience.

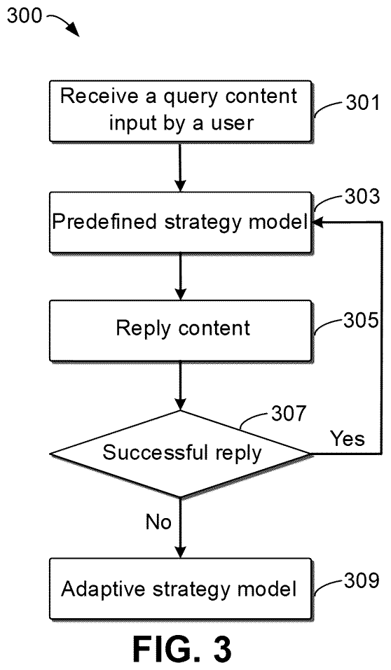

Hereinafter, example processes in illustrative embodiments will be described in detail with reference to FIGS. 3 to 6. In embodiments of the present disclosure, the explanation is made in the order of replying to the query content by using a model, the process of replying to the query content, and determining the service mode according to a preset condition. The specific data referred to in the following description is exemplary and is not intended to limit the scope of protection of the present disclosure. It can be understood that the embodiments described below may also include additional actions not shown and/or may omit actions shown, and the scope of the present disclosure is not limited in this regard.

FIG. 3 is a flow chart of a method 300 for replying to a query content using a model in some embodiments of the present disclosure. As shown in FIG. 3, at block 301, a query content input by a user is received. When the user inputs the query content, the query content can first be received by a predefined strategy model 303, which may be a model for making decisions and responses based on a preset rule. At block 305, a reply content is generated by the predefined strategy model. The predefined strategy model 303 can search for a match according to the query content and a preset rule base built therein, and give a corresponding reply. The preset rule may be formulated based on common query patterns, the service logic, the knowledge base, and the like.

At block 307, it is determined whether the predefined strategy model has made a successful reply. A successful reply indicates that the predefined strategy model 303 is sufficient to reply to the query content from the user, and is therefore a complete reply. When the predefined strategy model 303 fails to make a successful reply, for example, when the query content exceeds the preset rule range, the model cannot find a matching rule to generate a reply. If the query content is ambiguous or unclear, and the query input by the user may be ambiguous or unclear, such that the model cannot determine which rule to use to reply, then the adaptive strategy model 309 can be used to generate a reply. The adaptive strategy model 309 may be a model based on machine learning or deep learning, and can automatically adapt to a new query content. When the predefined strategy model 303 fails to reply, the adaptive strategy model 309 can take over and give a more accurate reply.

In this way, most common queries can be processed through the predefined strategy model 303, so as to meet the requirements of real-time user interactions, improve the response speed, reduce the complexity and computation amount of the adaptive strategy model 309, and improve the overall performance of the system. In addition, the rules of the predefined strategy model 303 are clear and interpretable, which can help users understand the decision-making process of the system and enhance the transparency and credibility of the system.

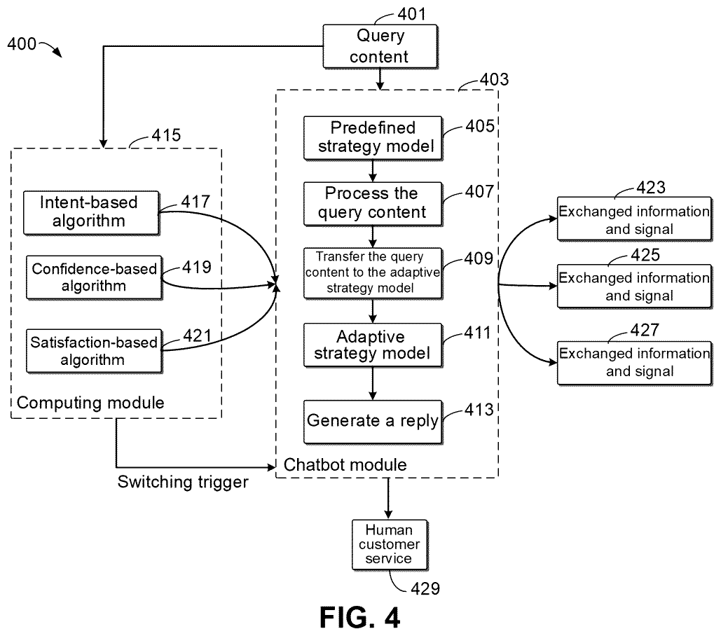

FIG. 4 is a schematic diagram of a process 400 of replying to a query content according to some embodiments of the present disclosure. As shown in FIG. 4, after a user inputs a query content 401, a reply to the query content 401 can first be generated by a chatbot module 403. The chatbot module 403 may include a predefined strategy model 405 and an adaptive strategy model 411. The predefined strategy model 405 may be a chatbot based on rules, and the adaptive strategy model 411 may be a chatbot based on machine learning. At block 407, the query content is processed by the predefined strategy model. After the user inputs the query content 401, it can first be processed by the predefined strategy model 405.

At block 409, the query content is transferred to the adaptive strategy model. When the predefined strategy model 405 fails to make a successful reply, for example, when the query content 401 exceeds the preset rule range, the model cannot find a matching rule to generate a reply. If the query content 401 is ambiguous or unclear, and the query input by the user may be ambiguous or unclear, such that the model cannot determine which rule to use to reply, then the adaptive strategy model 411 can be used to process the query content 401. At block 413, a reply is generated by the adaptive strategy model. When the predefined strategy model 405 fails to reply, the adaptive strategy model 411 can take over and give a more accurate reply. The response of the chatbot module 403 can be expressed by the following formula:

$$r = {f}_{w} ( q , {f}_{R} ( q ) , {f}_{M} ( q ) ) \qquad ( 1 )$$

where r represents the response of the model service module, q represents the query content, ƒ_{w} represents the function of the predefined strategy model combined with the adaptive strategy model, ƒ_{R} represents the function of the predefined strategy model, and ƒ_{M} represents the function of the adaptive strategy model.

In some embodiments, the computing module 415 can compute the intent parameter, the confidence parameter, and the emotion parameter in the query content 401, and decide whether to switch the service mode to human customer service 429 according to the plurality of parameters. In embodiments of the present disclosure, the intent parameter may indicate an intent-based switching decision, the confidence parameter may indicate a confidence-based switching decision, and the emotion parameter may indicate an emotion-based switching decision. When computing the intent parameter, the intent parameter can be generated based on the user intent and the preset intent set in the adaptive strategy model 411. An intent-based algorithm 417 can be expressed as:

$${H}_{I} = {f}_{I} ( q , I ) \qquad ( 2 )$$

where H_{I} represents the intent-based switching decision, q represents the query content, I represents the preset intent set, and ƒ_{I} represents the intent parameter generation function. In the process of generating the intent parameter, that is, in the process of determining whether to switch to the human customer service 429 according to the user intent, the identified user intent can be matched with the intent set to generate an evaluated intent value, and the evaluated intent value can be compared with a preset value. When the query content 401 is too complicated and exceeds the range of the intent set, the evaluated intent value is less than the preset value, and then an intent parameter indicating to switch to the human service is generated; and when the match level between the query content 401 and the intent set is high and the evaluated intent value is greater than the preset value, then an intent parameter indicating a decision not to switch is generated.

In some embodiments, when computing the confidence parameter, the confidence parameter can be generated based on the similarity between the query content and the training data of the adaptive strategy model 411, and a confidence-based algorithm 419 can be expressed as:

$${H}_{C} = {f}_{C} ( q , r , s , t ) \qquad ( 3 )$$

where H_{C} represents the confidence-based switching decision, q represents the query content, r represents the response of the adaptive strategy model, s represents the confidence score, t represents the preset value, and ƒ_{C} represents the confidence parameter generation function. In the process of generating the confidence parameter, that is, in the process of determining whether to switch to the human customer service 429 according to the confidence, the query content 401 can be matched with the training data of the adaptive strategy model 411. When the match level between the query content 401 and the training data is low, that is, s<t, a confidence parameter indicating to switch to the human service is generated, and when the match level between the query content 401 and the training data is high, that is, s>t, a confidence parameter indicating a decision not to switch is generated.

In some embodiments, when calculating the emotion parameter, that is, when determining the user satisfaction, an average emotional value can be determined based on feedback signals such as scores, emoticons, and keywords in the query content 401, and then the average emotional value is compared with a preset value to generate the emotion parameter. The satisfaction-based algorithm can be expressed as:

$${H}_{S} = {f}_{S} ( F ) \qquad ( 4 )$$

where H_{S} represents the emotion-based switching decision, F represents the feedback signal set from the user, and ƒ_{S} represents the emotion parameter generation function. In the process of generating the emotion parameter, that is, in the process of determining whether to switch to the human customer service 429 according to the user emotion, the average emotional value can be determined according to the feedback signals such as the user scores, the emoticons and the keywords in the query content 401. When the average emotional value is greater than the preset value, it indicates that the user satisfaction is low or gradually deteriorates over time, and then the emotion parameter indicating to switch to the human service is generated.

In embodiments of the present disclosure, the chatbot module 403 interacts with the signals and the computing module 415 through exchanged information. In the process of continuously generating replies by the chatbot module 403, the exchanged information and the signal 423 can be input into the module for computing the intent parameter in the computing module 415, the exchanged information and the signal 425 can be input into the module for computing the confidence parameter in the computing module 415, and the exchanged information and the signal 427 can be input into the module for computing the emotion parameter in the computing module 415. The exchanged information and the signals may include new query contents and generated replies.

In some embodiments, the service mode may be switched to the human customer service 429 when any one of the intent parameter, the confidence parameter, and the emotion parameter indicates to switch. For example, when only the confidence parameter indicates to switch and the intent parameter and the emotion parameter indicate not to switch, a switching trigger instruction can be sent to the chatbot module 403 only according to the confidence parameter to switch the service mode to the human customer service 429.

In some embodiments, a decision parameter can also be generated according to the intent parameter, the confidence parameter, and the emotion parameter, and it is decided whether to switch the service mode according to the decision parameter. The decision parameter can be generated by various methods. For example, different weights can be assigned to the intent parameter, the confidence parameter, and the emotion parameter, and the weights can be determined according to the importance of the different parameters for decision making. Then, a weighted sum is computed according to the value of each parameter and the corresponding weight to obtain the decision parameter. The computed decision parameter is compared with a preset threshold, and if it reaches or exceeds the threshold, a switching trigger instruction is sent to the chatbot module 403 to switch the service mode to the human customer service 429.

In some embodiments, the decision parameter can also be generated by a method based on a fuzzy logic, and it is decided whether to switch the service mode according to the decision parameter. First, such precise data, such as the intent parameter, the confidence parameter and the emotion parameter, is transformed into a fuzzy range, like a fuzzy description such as “low,” “medium” and “high.” Then a fuzzy rule is formulated according to expert knowledge or historical data. For example, if the confidence is in the “high” range, there is no need to switch the service mode. Using the method of fuzzy inference, a fuzzified parameter value is substituted into the fuzzy rule for inference to obtain a fuzzy output. Finally, the fuzzy output is transformed into a clear decision parameter. According to the decision parameter, it is decided whether to send a switching trigger instruction to the chatbot module 403 to switch the service mode to the human customer service 429.

In some embodiments, the decision parameter can also be generated by a method based on multiple criteria. In the process of generating the decision parameter, it is first necessary to define the decision goal, that is, whether the service mode should be switched. Then, the intent parameter, the confidence parameter, and the emotion parameter are determined as the criteria for evaluating this decision. To reflect the importance of these criteria in the decision-making process, a weight is assigned to each criterion. After that, specific information about these criteria is collected, and the evaluation is made according to their respective weights and numeric values. Finally, based on the evaluation result, an optimal scheme is determined, that is, whether the service mode should be switched.

In some embodiments, the decision parameter can also be generated based on a weighted scoring method. First, the intent parameter, the confidence parameter, and the emotion parameter are determined as valuation indicators. Then, corresponding weights are set for these valuation indicators, and then each valuation indicator is scored according to the actual situation. Then, by computing the weighted score of each valuation indicator and adding all the weighted scores, a comprehensive score is obtained, which is the decision parameter. Finally, the decision is made according to the comprehensive score, and if the comprehensive score reaches or exceeds a preset threshold, the service mode is to be switched.

In this way, instead of relying on a single threshold or rule, multiple standards and signals are used to determine the optimal switching point, which can adapt to different user preferences, question urgencies, question complexities, and failures of the model service, thereby realizing a smooth and seamless transition from the model service mode to the human service without interrupting the conversation and losing information. Also, the hybrid method of a predefined strategy model and an adaptive strategy model is adopted, which can improve the scalability and adaptability of the model service mode to provide better user experience and results.

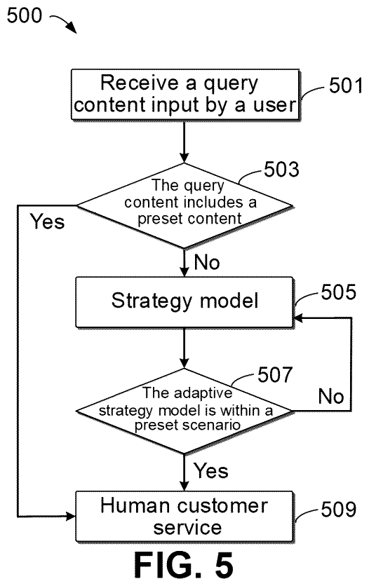

FIG. 5 is a flow chart of a method 500 for determining a service mode according to a preset condition and a preset scenario according to some embodiments of the present disclosure. As shown in FIG. 5, at block 501, a query content input by a user is received. The query content input by the user can be received by the predefined strategy model, or the query content input by the user can be received by the adaptive strategy model, to generate a reply. At block 503, it is determined whether the query content includes a preset content. In the absence of such preset content, strategy model 505, illustratively comprising at least one of a predefined strategy model and an adaptive strategy model, is applied. The preset content is used to determine whether it is necessary to switch from the current automatic service mode to the human service mode. The preset condition can be set based on factors such as the user behavior, the query content, or the system status. For example, if the user repeats the same query many times or states that human service is needed, it indicates that the user is not satisfied with the response of the model service mode, and then it is necessary to switch to the human customer service 509. If the query content of the user contains sensitive or personal information, such as a credit card number or password, in which case a secure and confidential communication channel is needed, it is necessary to switch to the human customer service 509.

At block 507, it is determined whether the adaptive strategy model is within a preset scenario. The preset scenario may be a predefined scenario where it is necessary to switch to the human customer service 509, which can be set based on the overall environment and context information. For example, if the model service mode cannot generate a response to the user query, or generates an irrelevant or inappropriate response, it is necessary to switch to the human customer service 509.

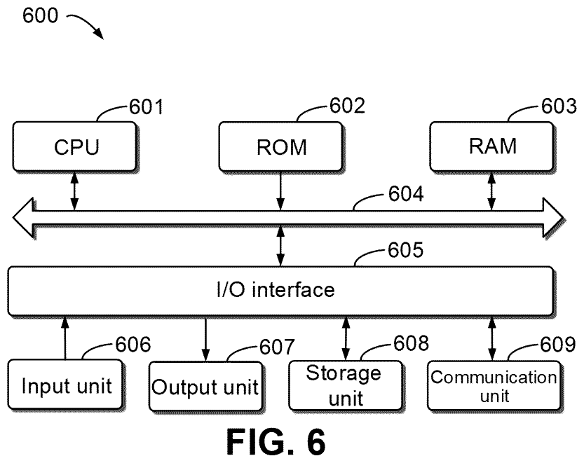

FIG. 6 is a block diagram of an example device 600 that can be used to implement embodiments of the present disclosure. As shown in the figure, the device 600 includes a computing unit 601, illustratively implemented as at least one central processing unit (CPU), that can perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The computing unit 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, and the like; an output unit 607, such as various types of displays, speakers, and the like; the storage unit 608, such as a magnetic disk, a compact disc, and the like; and a communication unit 609, such as a network card, a modem, a wireless communication transceiver, and the like. The communication unit 609 allows the device 600 to exchange information/data with other devices via a computer network, such as the Internet, and/or various telecommunication networks.

The computing unit 601 may be various general-purpose and/or special-purpose processing components with processing and computing power. Some examples of the computing unit 601 include, but are not limited to, the above-noted one or more CPUs, a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs various methods and processes described above, such as the method 200. For example, in some embodiments, the method 200 may be implemented as a computer software program that is tangibly included in a machine-readable medium, such as the storage unit 608. In some embodiments, part of or all the computer program can be loaded and/or installed onto the device 600 via the ROM 602 and/or the communication unit 609. When the computer program is loaded to the RAM 603 and executed by the computing unit 601, one or more steps of the method 200 described above can be performed. Alternatively, in other embodiments, the computing unit 601 may be configured to perform the method 200 in any other suitable manners (such as by means of firmware).

The functions described herein can be executed at least in part by one or more hardware logic components. For example, without limitation, example types of available hardware logic components include: a field programmable gate array (FPGA), an application specific integrated circuit (ASIC), an application specific standard product (ASSP), a system on chip (SOC), a complex programmable logic device (CPLD), and the like.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, this should not be construed as an indication that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the particular features and actions described above are merely example forms of implementing the claims.

What is claimed is:

1. A method for determining a service mode, comprising:
generating an intent parameter by identifying a user intent in a query content input by a user;
generating an emotion parameter by analyzing a sentiment inclination in the query content;
generating a confidence parameter by analyzing a similarity between the query content and training data for training an adaptive strategy model; and
determining a service mode for replying to the query content based on the intent parameter, the emotion parameter, and the confidence parameter.

2. The method according to claim 1, further comprising:
in response to receiving the query content input by the user, generating a reply content based on the query content by a predefined strategy model;
based on the reply content, determining whether the predefined strategy model has provided a complete reply; and
in response to the predefined strategy model having not provided a complete reply, generating a reply content based on the query content by the adaptive strategy model.

3. The method according to claim 1, wherein generating the intent parameter comprises:
generating an evaluated intent value based on the user intent and a preset intent set; and
generating the intent parameter based on the evaluated intent value and a preset value.

4. The method according to claim 1, wherein generating the emotion parameter comprises:
determining an average emotional value based on scores, emoticons and keywords in the query content; and
generating the emotion parameter based on the average emotional value and a preset value.

5. The method according to claim 1, wherein determining a service mode for replying to the query content comprises:
determining a decision parameter based on the intent parameter, the emotion parameter, and the confidence parameter; and
determining whether the service mode is a model service mode using an adaptive strategy model or a direct service mode based on the decision parameter and a preset value.

6. The method according to claim 5, wherein determining the decision parameter comprises:
determining evaluation factors corresponding to the intent parameter, the emotion parameter, and the confidence parameter, the evaluation factors being one of a level or a weight; and
determining the decision parameter based on the evaluation factors corresponding to the intent parameter, the emotion parameter, and the confidence parameter.

7. The method according to claim 5, wherein determining the decision parameter comprises:
determining a service mode corresponding to the intent parameter, the emotion parameter, and the confidence parameter;
determining proximity between the service mode and a preset mode; and
determining the decision parameter based on the proximity.

8. The method according to claim 1, further comprising:
determining whether the query content comprises a preset content; and
determining that the service mode is a direct service mode in response to the query content comprising the preset content.

9. The method according to claim 1, further comprising:
determining whether the adaptive strategy model is in a preset scenario; and
determining that the service mode is the direct service mode in response to the adaptive strategy model being in the preset scenario.

10. An electronic device, comprising:
at least one processor; and
a memory coupled to the at least one processor and having instructions stored therein, wherein the instructions, when executed by the at least one processor, cause the electronic device to perform actions comprising:
generating an intent parameter by identifying a user intent in a query content input by a user;
generating an emotion parameter by analyzing a sentiment inclination in the query content;
generating a confidence parameter by analyzing a similarity between the query content and training data for training an adaptive strategy model; and
determining a service mode for replying to the query content based on the intent parameter, the emotion parameter, and the confidence parameter.

11. The electronic device according to claim 10, wherein the actions further comprise:
in response to receiving the query content input by the user, generating a reply content based on the query content by a predefined strategy model;
based on the reply content, determining whether the predefined strategy model has provided a complete reply; and
in response to the predefined strategy model having not provided a complete reply, generating a reply content based on the query content by the adaptive strategy model.

12. The electronic device according to claim 10, wherein generating the intent parameter further comprises:
generating an evaluated intent value based on the user intent and a preset intent set; and
generating the intent parameter based on the evaluated intent value and a preset value.

13. The electronic device according to claim 10, wherein generating the emotion parameter further comprises:
determining an average emotional value based on scores, emoticons and keywords in the query content; and
generating the emotion parameter based on the average emotional value and a preset value.

14. The electronic device according to claim 10, wherein determining a service mode for replying to the query content further comprises:
determining a decision parameter based on the intent parameter, the emotion parameter, and the confidence parameter; and
determining whether the service mode is a model service mode using an adaptive strategy model or a direct service mode based on the decision parameter and a preset value.

15. The electronic device according to claim 14, wherein determining the decision parameter comprises:
determining evaluation factors corresponding to the intent parameter, the emotion parameter, and the confidence parameter, the evaluation factors being one of a level or a weight; and
determining the decision parameter based on the evaluation factors corresponding to the intent parameter, the emotion parameter, and the confidence parameter.

16. The electronic device according to claim 14, wherein determining the decision parameter comprises:
determining a service mode corresponding to the intent parameter, the emotion parameter, and the confidence parameter;
determining proximity between the service mode and a preset mode; and
determine the decision parameter based on the proximity.

17. The electronic device according to claim 10, wherein the actions further comprise:
determining whether the query content comprises a preset content; and
determining that the service mode is a direct service mode in response to the query content comprising the preset content.

18. The electronic device according to claim 10, wherein the actions further comprise:
determining whether the adaptive strategy model is in a preset scenario; and
determining that the service mode is the direct service mode in response to the adaptive strategy model being in the preset scenario.

19. A computer program product tangibly stored on a non-transitory computer-readable medium and comprising machine-executable instructions, the machine-executable instructions, when executed by a machine, causing the machine to perform actions comprising:
generating an intent parameter by identifying a user intent in a query content input by a user;
generating an emotion parameter by analyzing a sentiment inclination in the query content;
generating a confidence parameter by analyzing a similarity between the query content and training data for training an adaptive strategy model; and
determining a service mode for replying to the query content based on the intent parameter, the emotion parameter, and the confidence parameter.

20. The computer program product according to claim 19, wherein the actions further comprise:
in response to receiving the query content input by the user, generating a reply content based on the query content by a predefined strategy model;
based on the reply content, determining whether the predefined strategy model has provided a complete reply; and
in response to the predefined strategy model having not provided a complete reply, generating a reply content based on the query content by the adaptive strategy model.
